(19) United States
(12) Patent Application Publication
(10) Pub. No.: US 2008/0111367 A1
(43) Pub. Date: May 15, 2008

(54) Removable binding for book pages

(75) Inventors: David J. McCabe, New Rochelle, NY (US); David E. Boundy, New York, NY (US); Adam R. Steinert, New York, NY (US)

Correspondence Address: WILLKIE FARR & GALLAGHER LLP;INTELLECTUAL PROPERTY LEGAL ASSISTANTS, 787 SEVENTH AVE, NEW YORK, NY, 10019-6099, US

(73) Assignee: David J. McCabe, New Rochelle, NY (US)

(21) Appl. No.: 11/448,386

(22) Filed: Jun. 6, 2006

(51) Int. Cl. B42D 1/00

(52) U.S. Cl. 281/21.1

(57) ABSTRACT

Binding pages of a book. A spine member has spine coupling features. A plurality of spinelet members each have one or more spinelet coupling features designed to repeatedly conjoin with and disconnect from a corresponding one of or set of the spine coupling features, or to spinelet coupling features of other spinelet members, and have a binding surface designed to provide a permanent or semi-permanent attachment for one or more pages of the book. A kit for binding books may include a device for making spinelet members, the device being adjustable to make spinelet members of varying widths corresponding to thicknesses of desired sections of the book.

### BACKGROUND

This invention relates to bookbinding.

### BRIEF SUMMARY

In general, in a first aspect, the invention features an apparatus for binding pages of a book. A spine member has spine coupling features. A plurality of spinelet members each have one or more spinelet coupling features designed to repeatedly conjoin with and disconnect from a corresponding one of or set of the spine coupling features, and have a binding surface designed to provide a permanent or semi-permanent attachment for one or more pages of the book.

In general, in a second aspect, the invention features a kit for binding books. A device is designed for making spinelet members, each spinelet member having a binding surface designed to provide a permanent or semi-permanent attachment for sections of pages of a book, the spinelet members having spinelet coupling features designed to repeatedly be conjoined with and disconnect from other spinelet members to form a spine of the book, the device being adjustable to make spinelet members of varying widths corresponding to thicknesses of desired sections of the book.

In general, in a third aspect, the invention features a method of binding a book. Two or more sections of pages of the book are bound to binding surfaces of corresponding spinelet members, the binding being permanent or semi-permanent. The spinelet members are conjoined to a spine member using coupling features of the spinelet members and the spine, the coupling features being designed to permit repeated conjoining and disconnection between the spinelet members and the spine member.

In general, in a fourth aspect, the invention features a method of reading a book, comprising the steps of: (a) obtaining a book, the book being divided into sections of pages, each section being permanently or semi-permanently bound to a corresponding spinelet member, the spinelet members being coupled to a spine by coupling features that are repeatedly detachable and reattachable; (b) detaching one of the sections of the book from the spine by detaching the coupling features of the corresponding spinelet; (c) carrying the detached section of the book away from the remaining sections of the book; and (d) reassembling the book by reattaching the detached section to the spine.

In general, in a fifth aspect, the invention features a book. A spine member has a length, a width, and a plurality of first coupling features raised or recessed thereon substantially parallel to the length. A plurality of spinelet members each have a side configured to repeatedly conjoin securely with and disconnect from the first coupling features, each spinelet member also having an opposite side permanently or semi-permanently binding one or more pages.

Embodiments of the invention may include one or more of the following features. The spinelet coupling features and spine coupling features may be designed to permit repeated conjoining and disconnecting without the use of special tools or adhesives, for example, using an end-sliding joint, or hooks and pockets or slots to receive the hooks, or snaps, or hook-and-loop fasteners. The spinelet coupling features may be spinelet-to-spinelet coupling features designed to repeatedly conjoin the spinelets directly with each other and disconnect the spinelets from each other. The coupling features may include a lock for release by finger pressure. The spine member is designed for hingedly or flexibly attachment to front and back covers having toughness to be protective of pages of the book. Two of the spinelet members may be formed a the request of a specific customer for the specific book, to have widths that differ from each other, corresponding to thicknesses of corresponding customer-designated sections of pages of the book. The spine and spinelet members may be designed to be cut to length to correspond to a height of pages of a commercially-significant broad range of pre-existing books. Pages of the book may be attached to the spinelet members, the spinelet members being conjoined with the spine to form a bound book. The pages may be sewn signatures of pages of the book, or may be glued or stapled to the spinelet members.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF THE DRAWINGS

FIGS. 1, 4, 5 and 6 are perspective views of open books.

FIGS. 2a, 2b, 3a and 3b are end views of books.

### DESCRIPTION

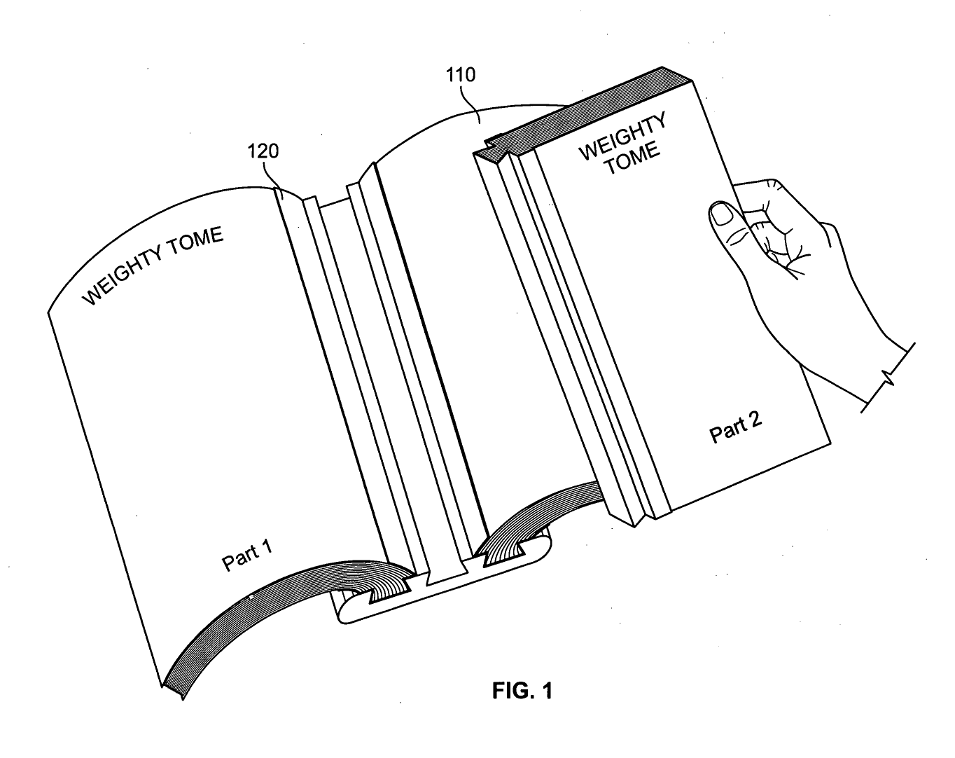

Referring to FIG. 1, in a multi-spinelet book binding arrangement, book 100 may be divided into sections 110, 112. Each section 110, 112 may have pages 114, 116 that are permanently or semi-permanently bound to a respective spinelet 120, 122. In turn, the spinelets may have coupling features 124, 126 that couple the spinelets 120, 122 to spine 130. Spine 130 may have coupling features 134, 136 that couple to the coupling features 124, 126 of spinelets 120, 122. Spine 130 may also have attached covers 138. Coupling features 124, 126, 134, 136 of binding arrangement 100 may allow one or more sections 110, 112 to be separated out from the book 100, for example, to be carried about. Later, removed sections 110, 112 may be recoupled to the rest of the book. Binding arrangement 100 may be advantageous for large textbooks, or other books that need to be carried about and where the portion of interest can be predicted sufficiently to allow that portion to be separated from the rest of the book, to reduce the load being carried.

In one example, coupling features 124, 126, 134, 136 may be mating dovetail tongues and grooves.

In some cases, pages of a section 110, 112 may be permanently attached to a spinelet, for example so that they cannot be removed without damaging the pages or the spinelet. In other cases, the pages may be semi-permanently attached to a spinelet, for example by using a binding technique that allows the pages to be removed without permanently damaging either the pages or the spinelet, or that requires damaging the spinelet and replacement with a new spinelet for rebinding, but the pages will remain fixed to the spinelet during normal use of the book. Examples of attachment include sewn signature binding and glue perfect binding, removable pins, openable and closeable snaps, or staples, or a hot knife melt post-though-hole system similar to that used in the VeloBind™ system. Binding methods that do not wrap the spinelet around the pages may result in thinner, more-compact books. Other examples of permanent or semi-permanent attachment are discussed below. In other cases, the pages may be readily removable from and replaceable in/on the spinelet.

In some cases, the spinelets may be disconnectable from and re-connectable to the spine without tools. In other case, disconnection may require the use of an everyday object, such as a coin, as a tool. In other cases, disconnection may require a special key.

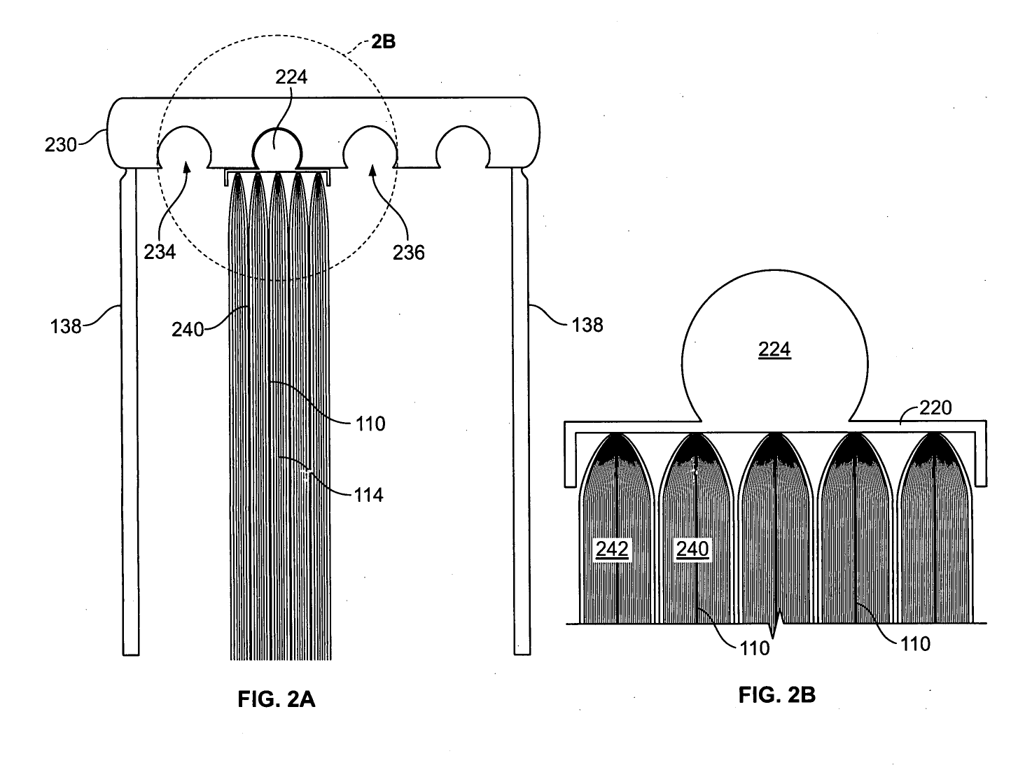

Referring to FIGS. 2a and 2b, a multi-spinelet binding system may include a spine 230, front and back covers 138, and one or more sections 110, 112. Each spinelet 220 may have a circular tongue 224 that is shaped to couple with a corresponding circular groove 234, 236 in spine 230, thereby attaching sections 110, 112 to spine 230. Other interlocking shapes for end-sliding engagement may be used as well. Each section 110, 112 may in turn include a spinelet 220 attached to a set of pages 114, 116, attached permanently or semi-permanently, as described above. In the example of FIGS. 2a, 2b, pages 114 may be attached to spinelet 220 as one or more signatures 240, 242.

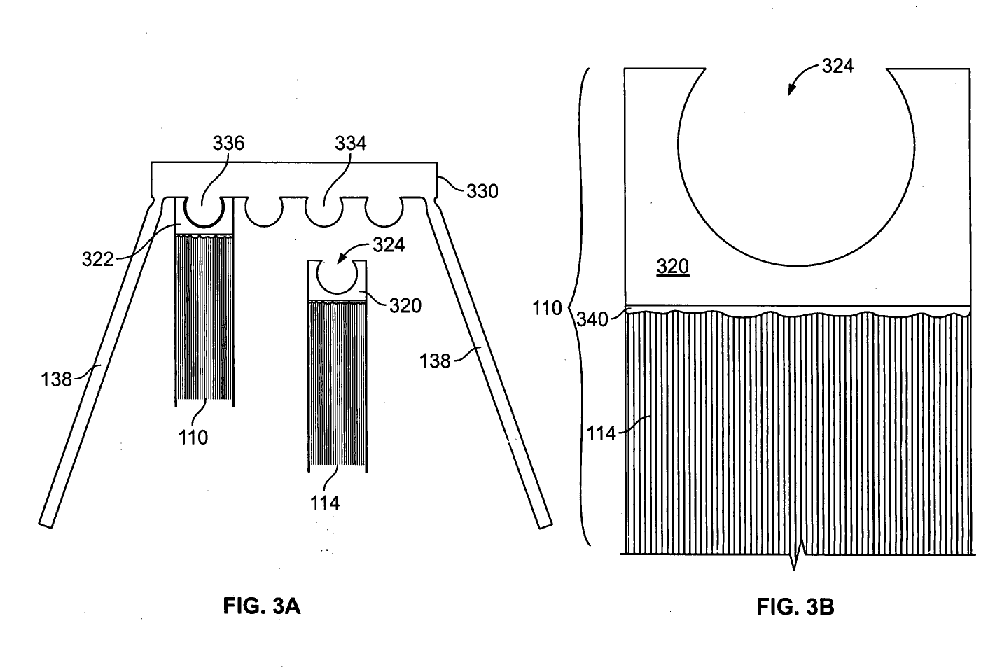

Referring to FIGS. 3a and 3b, spine 330 may include one or more circular or dovetail tongues 334, 336. Each section 110, 112 may have a spinelet 320, 322 with groove 324, 326 that is shaped to couple with a corresponding tongue 334, 336 of spine 330. In the example of FIGS. 3a, 3b, pages 314 are attached to spinelet 320 by a perfect glue binding 340.

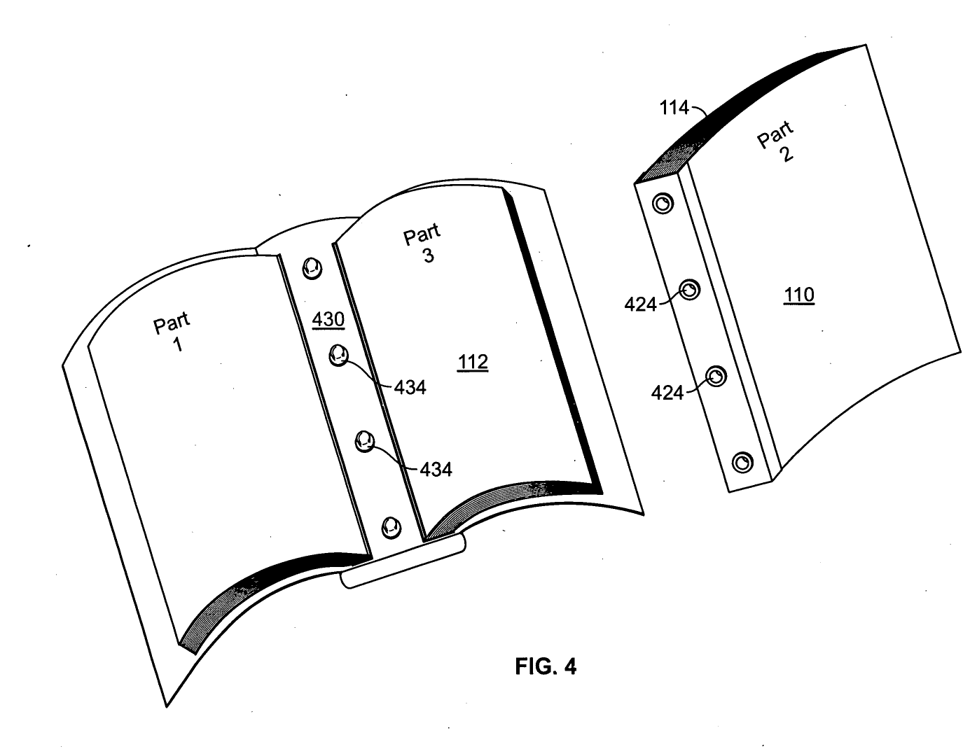

Referring to FIG. 4, spine 430 may include one or more female snap connectors 434. Spinelets 420, 422 may have one or more male snap connectors 424 arranged to couple with female snap connectors 434. Alternatively, spinelet 420 may have female snap connectors, and spine 430 may have corresponding male snap connectors.

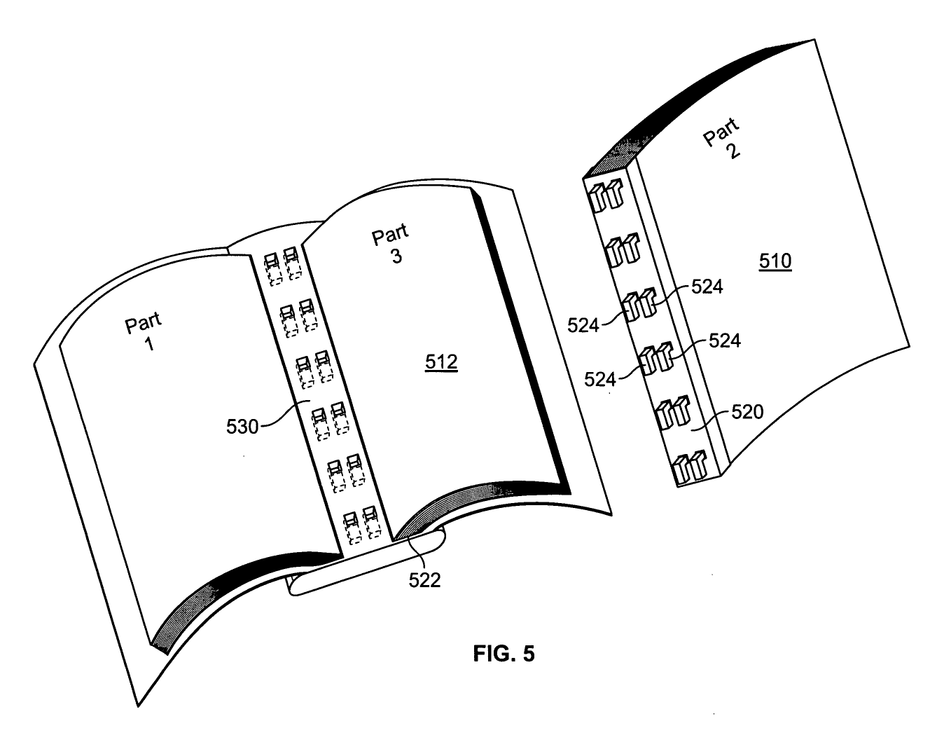

Referring to FIG. 5, spine 530 may include one or more pockets or slots 534. Spinelets 520, 522 may have one or more hooks or tabs 524 that are shaped to interlock with pockets or slots 534. Alternatively, pockets or slots 534 may also be located on spinelet 520, and mating hooks or tabs 524 may be located on spine 530. In some cases, for example where the number of connect-disconnect cycles for any particular spinelet will be relatively small, less expensive joint technologies may be used. Other configurations for spinelet connectors 124 and spine connectors 136 may include T-locks, various configurations of pins fit into holes, various click or slide joints, hook-and-loop fasteners, ratcheting connectors, various forms of joint that require finger pressure or the heat of a hand for release, or may use certain kinds of adhesives.

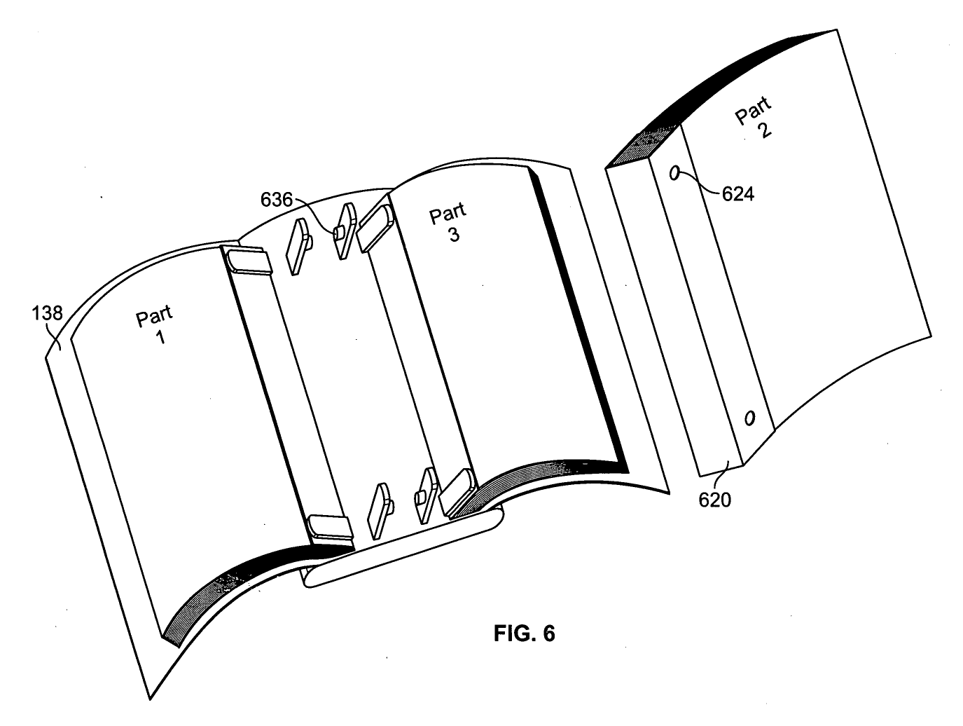

Referring to FIG. 6, one or more sets of tabs 634 may extend outwardly from spine 630. Tabs 634 may have protrusions 635. Corresponding indentations 624 may be located on spinelet 620, allowing spinelet 620 to be repeatedly attached to and detached from spine 630. Alternatively, the locations of protrusions 635 and indentations 624 may be reversed. In another embodiment, tabs 634 may extend from spinelet 620 and be configured to attach to spine 630.

Other mechanisms may be used to couple spinelets 120, 122, 220, 320, 420, 520, 620 to spine 130, 230, 330, 430, 530, 630. The widths of spinelets 120, 122, 220, 320, 420, 520, 620 and the corresponding spacing of coupling features 134, 234, 424, 434, 534, 634 across spine 130, 230, 330, 430, 530, 630 may be uniform, or may be variable to accommodate sections 110, 112 of varying widths. In some cases, each section 120, 122 may have a set of covers for durability during carrying; generally these section covers may be of thinner material than the main covers 138 of the entire book 100.

Spine 130 and spinelets 120, 122 may be made from a variety of materials including plastic and rubber polymers, metals, fabrics, paper products, or leather. The components of the multi-spinelet binding system may be manufactured in a variety of ways, including casting, extruding, pressing, stamping, molding, forming, and machining. The components of the multi-spinelet binding system may be manufactured in bulk, or they may be custom manufactured for specific applications.

Spines 130 and/or spinelets 120 may be custom- or semi-custom manufactured, or may be manufactured at point of sale or for aftermarket rebinding, for example, by arranging dies or molds of varying widths or spacings and extruding, casting, or forming the spine and/or spinelets to accommodate page sections with non-uniform widths or widths that are established after a fully-bound book is sold. In some cases, a machine for forming spines 130 and spinelets 120 may be sold or leased to a publisher or retailer, so that the publisher or retailer can configure the spacing of coupling members 134, etc. as required for a particular set of sections 120, 122. For example, a set of replaceable or moveable dies may be provided to allow the extrusion of “custom” configurations of spines 130 and spinelets 120 as needed for a particular publication and its division into sections.

The spine 130 and/or spinelet members may have a form that permits them to be cut to length, to adapt to the height of the pages of a book to be bound or rebound at point of sale or aftermarket.

In some cases, spinelets 120 may lock to each other, without a spine 130.

Multi-spinelet binding arrangement 100 may be useful for binding textbooks or other large books. Multi-spinelet binding arrangement 100 may also be useful for books distributed to small children. Additionally, multi-spinelet binding arrangement 100 may be used by copy shops for re-binding of existing books or the binding of course-packs or photocopied materials.

In some cases, books may be originally bound and sold using multi-spinelet binding arrangement 100.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

The invention claimed is:

1. An apparatus for binding pages of a book, comprising:
a spine member having spine coupling features; and
a plurality of spinelet members, each spinelet member having one or more spinelet coupling features designed to repeatedly conjoin with and disconnect from a corresponding one of or set of the spine coupling features, and having a binding surface designed to provide a permanent or semi-permanent attachment for one or more pages of the book.

2. The apparatus of claim 1, wherein:
the spinelet coupling features and spine coupling features are designed to permit repeated conjoining and disconnecting without the use of special tools or adhesives.

3. The apparatus of claim 2, wherein:
the spinelet coupling features and spine coupling features couple using an end-sliding joint.

4. The apparatus of claim 2, wherein:
the spinelet coupling features and spine coupling features include hooks and pockets or slots to receive the hooks.

5. The apparatus of claim 2, wherein:
the spinelet coupling features and spine coupling features include snaps.

6. The apparatus of claim 2, wherein:
the spinelet coupling features and spine coupling features include hook-and-loop fasteners.

7. The apparatus of claim 2, wherein:
the spinelet coupling features and spine coupling features include a lock for release by finger pressure.

8. The apparatus of claim 1, wherein:
the spine member is designed for attachment to front and back covers having toughness to be protective of pages of the book.

9. The apparatus of claim 1, wherein:
the spine member is hingedly or flexibly attached to front and back covers having toughness to be protective of pages of the book.

10. The apparatus of claim 1, wherein:
two of the spinelet members have widths that differ from each other, corresponding to thicknesses of corresponding sections of pages of the book.

11. The apparatus of claim 10, wherein:
the spinelet members having differing widths have been formed at the request of a specific customer for the specific book.

12. The apparatus of claim 1, wherein:
the spine and spinelet members are designed to be cut to length to correspond to a height of pages of a commercially-significant broad range of pre-existing books.

13. The apparatus of claim 1, wherein:
the binding surface of the spinelets is designed to provide a permanent attachment for pages of the book.

14. The apparatus of claim 1, wherein:
the binding surface of the spinelets is designed to provide a semi-permanent attachment for pages of the book.

15. The apparatus of claim 1, further comprising:
pages of the book attached to the spinelet members, the spinelet members being conjoined with the spine to form a bound book.

16. An apparatus for binding pages of a book, comprising:
spine means with spine coupling means for coupling spinelet members; and
a plurality of spinelet means, each spinelet means having binding means for permanently or semi-permanently binding pages, and coupling means for repeatedly coupling with and releasing from the spine means.

17. The apparatus of claim 16, wherein:
the spine member is hingedly or flexibly attached to front and back covers having toughness to be protective of pages of the book.

18. The apparatus of claim 16, wherein:
two of the spinelet members have widths that differ from each other, corresponding to thicknesses of corresponding sections of pages of the book.

19. The apparatus of claim 18, wherein:
the spinelet members having differing widths have been formed at the request of a specific customer for the specific book.

20. The apparatus of claim 16, wherein:
the spine and spinelet members are designed to be cut to length to correspond to a height of pages of a commercially-significant broad range of pre-existing books.

21. The apparatus of claim 16, wherein:
the binding surface of the spinelets is designed to accept and be attached to sewn signatures of pages of the book.

22. The apparatus of claim 16, wherein:
the binding surface of the spinelets is designed to accept gluing of pages of the book.

23. The apparatus of claim 1, further comprising:
pages of the book attached to the spinelet members, the spinelet members being conjoined with the spine to form a bound book.

24. A kit for binding of books, comprising:
a device for making spinelet members, each spinelet member having a binding surface designed to provide a permanent or semi-permanent attachment for sections of pages of a book, the spinelet members having spinelet coupling features designed to repeatedly be conjoined and disconnected so as to conjoin the spinelet members to form a spine of the book, and disconnect the spinelet members from the book, the device being adjustable to make spinelet members of varying widths corresponding to thicknesses of desired sections of the book.

25. The kit of claim 24, wherein:
the spinelet coupling features are spinelet-to-spinelet coupling features designed to repeatedly conjoin the spinelets directly with each other and disconnect the spinelets from each other.

26. The kit of claim 31, wherein:
the spinelet coupling features and spine coupling features couple using an end-sliding joint.

27. The kit of claim 31, wherein:
the spinelet coupling features and spine coupling features include a lock for release by finger pressure.

28. The kit of claim 24, further comprising:
hingedly or flexibly attached front and back covers having toughness to be protective of pages of the book.

29. The kit of claim 24, wherein:
two of the spinelet members have widths that differ from each other, corresponding to thicknesses of corresponding sections of pages of the book.

30. The kit of claim 29, wherein:
the spinelet members having differing widths have been formed at the request of a specific customer for the specific book.

31. The kit of claim 24, wherein:
the spine and spinelet members are designed to be cut to length to correspond to a height of pages of a commercially-significant broad range of pre-existing books.

32. The kit of claim 24, wherein:
the binding surface of the spinelets is designed to provide a permanent attachment for pages of the book.

33. The kit of claim 24, wherein:
the binding surface of the spinelets is designed to provide a semi-permanent attachment for pages of the book.

34. The kit of claim 24, further comprising:
pages of the book attached to the spinelet members, the spinelet members being conjoined with the spine to form a bound book.

35. The kit of claim 24, wherein:
the binding surface of the spinelets is designed to accept and be attached to sewn signatures of pages of the book.

36. The kit of claim 24, wherein:
the binding surface of the spinelets is designed to accept gluing of pages of the book.

37. The kit of claim 24, wherein:
the binding surface of the spinelets is designed to accept staples attaching pages of the book.

38. A method of binding a book, comprising the steps of:
binding two or more sections of pages of the book to binding surfaces of corresponding spinelet members, the binding being permanent or semi-permanent;
conjoining the spinelet members to a spine member using coupling features of the spinelet members and the spine, the coupling features designed to permit repeated conjoining and disconnection between the spinelet members and the spine member.

39. The apparatus of claim 38, wherein:
the spinelet coupling features and spine coupling features include a lock for release by finger pressure.

40. The apparatus of claim 38, wherein:
the spinelet coupling features and spine coupling features couple using an end-sliding joint.

41. The apparatus of claim 38, wherein:
the spine member is hingedly or flexibly attached to front and back covers having toughness to be protective of pages of the book.

42. The apparatus of claim 38, wherein:
two of the spinelet members have widths that differ from each other, corresponding to thicknesses of corresponding sections of pages of the book.

43. The apparatus of claim 42, wherein:
the spinelet members having differing widths have been formed at the request of a specific customer for the specific book.
